(19) United States
(12) Patent Application Publication
(10) Pub. No.: US 2004/0044647 A1
(43) Pub. Date: Mar. 4, 2004

(54) Method and a device for activity-based presence information

(75) Inventor: Jukka-Pekka Salmenkaita, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/601,281

(22) Filed: Jun. 19, 2003

(30) Foreign Application Priority Data
Jun. 20, 2002 (FI) 20021211

(51) Int. Cl. G06F 7/00

(52) U.S. Cl. 707/1

(57) ABSTRACT

A method and a device (101) for providing user activity based presence information to members of a communication group. When communicating (106) with another member (102) of a group, the communications device (101) is arranged to send notification messages (108, 110) to other members (103, 104) of that particular group. The communication device (101) is correspondingly arranged to receive and store the user presence information acquired from other devices. Actions, which trigger the execution of the proposed method, are not restricted to any specific class as the user may specify certain actions to be included in a profile, which is connected to a plurality of communication groups.

### CROSS REFERENCE TO RELATED APPLICATIONS

This application claims priority under 35 USC § 119 to Finnish Patent Application No. FI 20021211 filed on Jun. 20, 2002.

### TECHNICAL FIELD

The present invention relates to a method and a device for providing distributed user activity-based presence information in a telecommunications network.

### BACKGROUND OF THE INVENTION

Many traditional network applications such as Internet chat room programs offer a centralized way of exchanging data and/or updating the user presence information via a server. Launching a client application causes a notification message to be sent to the server, wherein the corresponding user presence information is updated in the server database. Users can typically acquire the current connection state of preferred persons by accessing the server and sometimes also adjust their own presence profile according to a set of predefined rules. The available presence information is often limited to the simple on-line/off-line type statements.

Document US20020038388 discloses a system and a method for capturing web interactions for further user manipulation. In so-called “collaboration mode” the user is able to share his interactions with other users logged on the system using a dedicated server module comprising a messaging server and a database server. A messaging server handles the collaboration between the user client and the server module, which includes a messaging server engine such as an IRC (Internet Relay Chat) server. A data server is responsible for data recording and conferences management in overall.

Document WO9816045 discloses a communication system wherein a network server maintains a list of users. According to the proposed solution, a communications terminal includes a connection notification apparatus, which informs the network server when the user is connected to the network. In addition, the user may define a list of users whose network connection status should be inspected and the server provides the requested information. Every user has a permanent and unique identification code; therefore the identification is preferably independent of the used communication terminal. The user may separately allow various information, such as localization data, exchanged with other users.

Although prior art solutions described above are certainly applicable in a number of cases, they do not serve all kinds of communication purposes so well. For example, in mobile communication systems the user is most of the time “on-line” and the simple connection state information hardly provides any valuable information to anyone. The user may not have a terminal with himself or then he may be just temporarily unreachable, in a middle of a meeting etc. Additionally, many service security and reliability issues are not covered in current solutions.

### SUMMARY OF THE INVENTION

The object of the present invention is to overcome the aforesaid problems. The invention discloses a method and a device for providing user activity-based presence information to a set of users belonging to the same communication group. In the basic method, when two or more group members are communicating with each other, they also inform other members about current activity by sending them a notification. In a more cultivated solution, actions executed by the device of the invention are mapped to user profiles, which are in turn associated with at least one communication group.

Finally, notifications are sent to all members of said groups. This decentralized notification method with two different variations is reasonably simple to implement but nonetheless versatile and does not require servers, which are often prone to crash and vulnerable to hacking. The invention is characterized by what is stated in the appended claims.

According to the invention, a method for notifying communication group members, wherein said notifying is to be performed by a personal communications device operable in a telecommunications network, wherein at least one communication group and the members of said communication groups have been defined in said personal communications device, said device executing actions, comprises the steps of

defining the communication actions associated with the notification method,

identifying the communication actions associated with the notification method,

identifying a communication group having the far-end party of the communication action as a member, and

sending notifications to target devices, the users of which belonging to at least one identified communication group.

In another aspect of the invention, a method for notifying communication group members, wherein said notifying is to be performed by a personal communications device operable in a telecommunications network, wherein at least one communication group and the members of said communication groups have been defined in said personal communications device, said device executing actions, comprises the steps of

defining the associations of profiles with actions,

defining the associations of profiles with communication groups,

identifying the actions associated with a profile,

mapping actions to profiles connected to at least one communication group, and

sending notifications to target devices, the users of which belonging to at least one communication group.

In a further aspect of the invention, a personal communications device operable in a telecommunications network comprises processing means and memory means for processing and storing instructions and data, and said device is arranged to identify actions from a plurality of actions, further arranged to associate said identified actions with at least one communication group, and finally arranged to send notifications to target devices, the users of which belonging to at least one communication group.

The term “action” refers to any activity executed by a personal communications device either automatically or by the user initiative.

The term “address table” refers to any kind of stored entity of data comprising contact information of persons, which are supposed to get the notification messages to be sent according to the invention. Contact information is presented in a form exploitable by a personal communications device, e.g. as phone numbers or network addresses.

The term “communication group” refers to a plurality of persons who are somehow connected together, defined and stored in a memory of a personal communications device. In some cases the definitions of communication groups can be retrieved from an external device such as a server to said personal communications device. The connecting factor can be friendship, profession, work, hobby, family relations or whatever reason the user of a personal communications device has found useful.

In one embodiment of the invention a personal communications device supports defining communication groups comprising a plurality of users with appropriate addressing information. When communicating with another member of a group, said communications device is also arranged to send a notification message to other members of that particular group. Said communications device is correspondingly arranged to receive and store the user presence information acquired from other devices.

In another embodiment of the invention the scope of the embodiment above is expanded by exploiting several profiles including a plurality of actions. When an action belonging to a certain profile is executed, members of the communication group(s) associated with that profile are to be notified by said communications device.

In a further embodiment of the invention a personal communications device having initiated a communication task with another communications device is arranged to send a notification message on behalf of said another communications device.

In a further embodiment of the invention a visual and/or audio symbol is attached to each communication group and upon detecting activity in a group, a symbol associated with that group is presented to the user.

### BRIEF DESCRIPTION OF THE DRAWINGS

In the following, the invention is described in more detail by reference to the attached drawings, wherein

FIG. 1 illustrates the overall concept of the invention wherein a communication group consists of four persons equipped with compatible personal communications devices;

FIG. 2 is a block diagram of a personal communications device, substantially a mobile terminal, capable of sending and receiving notification information according to the invention;

FIG. 3 is a flow diagram disclosing a first embodiment of the invention;

FIG. 4 is a flow diagram disclosing a second embodiment of the invention; and

FIG. 5 depicts a possible appearance of a notification message on a terminal display according to the second embodiment of the invention.

### DETAILED DESCRIPTION

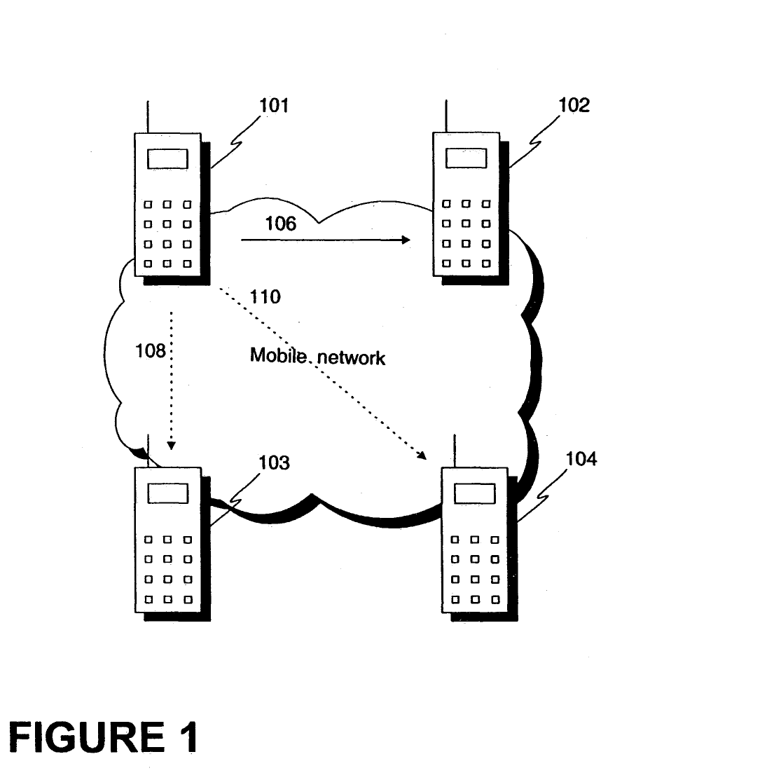

Referring to FIG. 1, the basic elements involved in the inventive concept are a bunch of personal communications devices 101, 102, 103, 104, preferably mobile terminals, connected to a mobile network such as GSM (Global System for Mobile communications) or UMTS (Universal Mobile Telecommunication System). The users of said devices 101-104 belong to the same communication group, for example a “buddy list”, defined and stored in the memory of said devices. Considering this particular invention, the communication group may not have to share exactly same members in every single personal communications device, although it definitely would make sense, probably providing the best synergy for exploiting a proposed notification method. The user of device 101 initiates a communication by sending a SMS (Short Message Service) message 106 to another group member equipped with device 102 and according to the invention, device 101 is also supposed to inform the other two devices 103, 104 called “target devices” about the current activity status. Thus said device 101 sends separate notification messages 108, 110 to target devices 103, 104 as they were not involved in the original message transaction 106. After the far-end party has read the message 106, the device 102 may correspondingly notify target devices 103, 104 about its activity status. As the communication between group members occasionally goes on by e.g. SMS messaging or exploiting real-time methods such as voice calls, all related persons will get notification messages for updating the presence information of active members. Naturally the notification feature should be on/off switchable as if, for example, SMS or MMS (Multimedia Messaging Service) messaging based discussion gets intense as it sometimes does, the rate of incoming notifications may be annoyingly high, surely depending on the used communication method. On/off switching functionality, e.g. simple software controlled parameter to be checked before sending notifications, can be made discrete for sending and receiving directions. Also minimum time intervals etc. for specifying notify resend period can be defined to automatically prevent identical notifications to be transmitted again and again during an ongoing communication session between a plurality of the communication group members. However, if notifications are most of the time non-intrusive, such as short ambient sound signals, and require no further actions from the recipient, switching functionality may not be necessary.

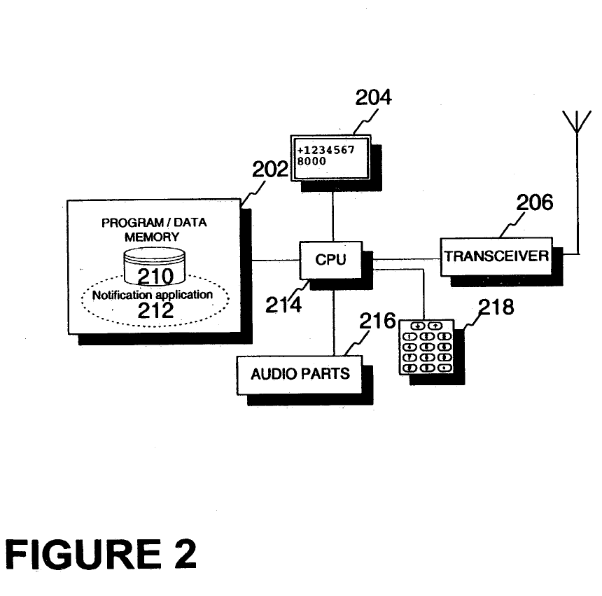

Referring to FIG. 2, basic components of said personal communications device, preferably a mobile terminal, capable of sending and receiving notification information are presented. A memory 202 and a processing unit 214 are required for processing and storing instructions and data. A display 204 and a user interface 218 are typically needed for providing necessary device control and data visualization means to the user. Transceiver 206 handles data transmission over an air interface. Audio parts 216 include e.g. transducers and amplifiers necessary for interfacing acoustic signals such as speech and music with said device. Memory 202 comprises a database 210 for storing user/contact information, communication group and action profile definitions etc., and a specific notification application 212 responsible for executing the notification method in accordance with the invention. It has to be noted that said personal communications device may actually consists of two or more separable devices, which communicate with each other exploiting e.g. a wireless Bluetooth link. One of the devices may provide a connection to the actual communication network possibly utilizing components similar to the ones presented above, while another device may just act as a portable user interface.

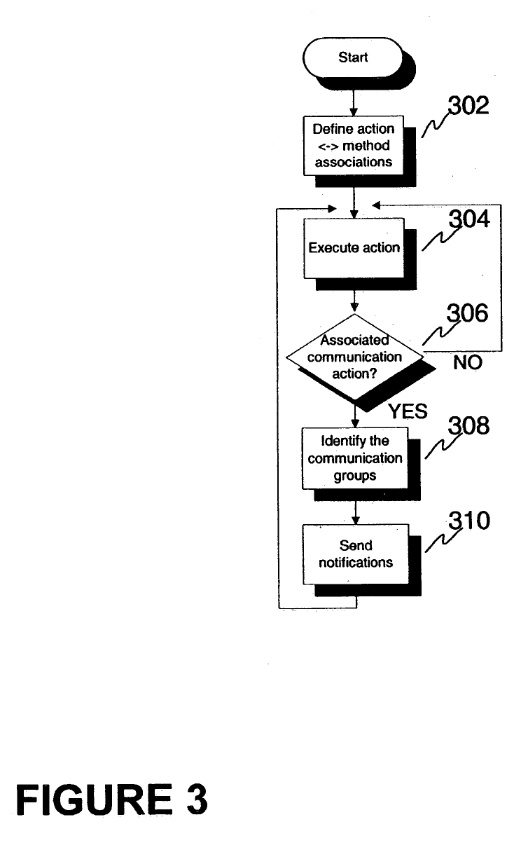

FIG. 3 includes a flow diagram disclosing a first embodiment of the invention. In this particular example, the involved personal communications device is a mobile terminal equipped with additional invention related software. Communication actions associated with the proposed method have been predefined in the terminal, see step 302. The notification procedure is originally initiated by the user who decides to send a SMS message to one of his buddies belonging to a certain communication group, the members of which have been defined in consensus by the group members themselves beforehand. A corresponding new task for handling required SMS transactions is generated. Next the terminal begins executing various task related actions including e.g. composing a new SMS message with necessary header information and payload, requesting the recipient ID and other required communication information from the user, and finally sending the generated message. Notification application 212 monitors executed actions 304 and according to predetermined rules, which may be at least partially defined by the user, identifies the communication actions 306, which trigger the further execution of the presented method. Sending a message is a communication action and therefore recognized by said application 212. Next the mobile terminal associates the recipient with a communication group 308 and transmits a notification message to all group members having not received the original message, see step 310. In practise, association can be implemented by simply retrieving the communication group definitions from the user database 210 including the far-end party information.

If the original message has been sent to many persons belonging to several communication groups or correspondingly, if the single recipient is a member in a plurality of groups, the notification method applies to all concerned groups unless otherwise defined. Alternatively, the execution of the notification procedure can be limited e.g. just to a certain person, for example the first one located in a recipient list of the message and groups associated with him.

While identifying the recipient with certain communication group(s), the mobile terminal has to keep track of all members of various groups targeted for notification. The terminal may, for example, store related members' phone numbers or IP (Internet Protocol) addresses in a temporary address table according to which the notifications are finally to be sent.

The communication actions, which launch the presence updating method in this first embodiment, can e.g. include sending and receiving messages and e-mail (electronic mail), initiating and answering calls, or any other procedures involving interaction of several group members. The recipient/far-end party of said communication action is essentially the factor, which defines the target group(s) for sending the notifications.

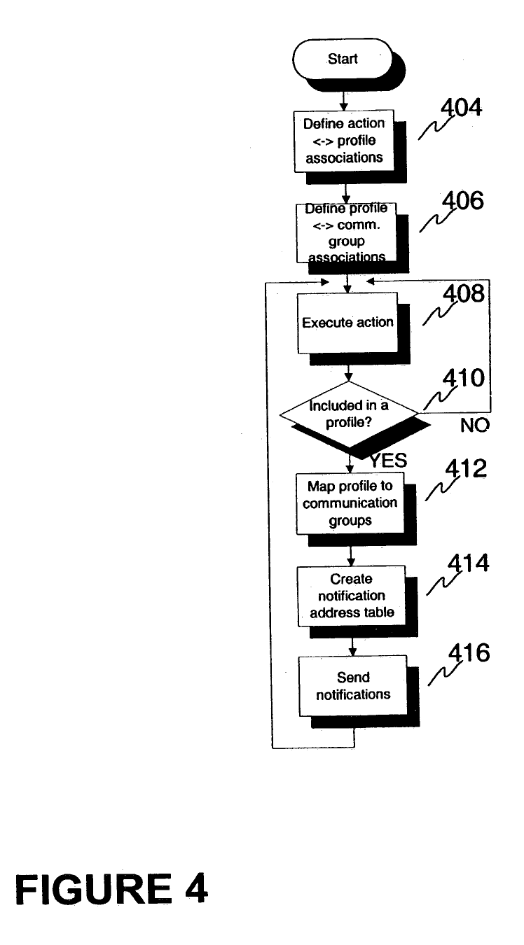

In another embodiment of the invention, see FIG. 4, the user is equipped with a modern mobile terminal supporting Internet connections and comprising a WWW (World Wide Web) browser. The user is a member of a few communication groups relating both to his work and hobbies. Communication groups have been explicitly defined in his mobile terminal by the necessary, group member specific addressing information. The user has also associated certain actions with certain profiles 404 and linked those profiles to a number of communication groups, step 406. This time the user decides to check the WWW site of his sailing club for new and updated content, so he initiates the execution of several interrelated and mostly automated actions 408 for fulfilling the task. Automated actions relate to proper data connection management and required manual actions are mainly linked to interactive selections and decision-making, such as selecting an interesting WWW page to be followed etc. Accessing the sailing club's WWW site has been defined to belong in a sailing related hobby profile by the user as when he is having a relaxed opportunity of surfing the club site, he is not normally bothered by occasional communication attempts from other people with same hobby. Usually it is even fun and entertaining to swap opinions with persons having a similar “spirit” without need to specifically contact them first. Thus, the notify message can be seen as an unofficial announcement “I'm here!” without pushing anyone to answer. The mobile terminal the user is carrying classifies data fetching from the club's site as a profiled action 410 and then determines all related communication groups associated with that profile, step 412. Groups include certain individual members, the contact addresses of which are retrieved from the contact database 210, e.g. “phone book”, in step 414 to a temporary address table comprising each retrieved contact address only once. The notifications are finally sent according to the address table to all found members possibly belonging to several different groups, step 416. When the recipient receives the notification, it will be presented to him in a favourable way as well as the recipient's personal communication device may then automatically maintain a history log of group related actions and person specific activity/presence info by storing the information gathered from received notifications to the database 210 of his mobile terminal.

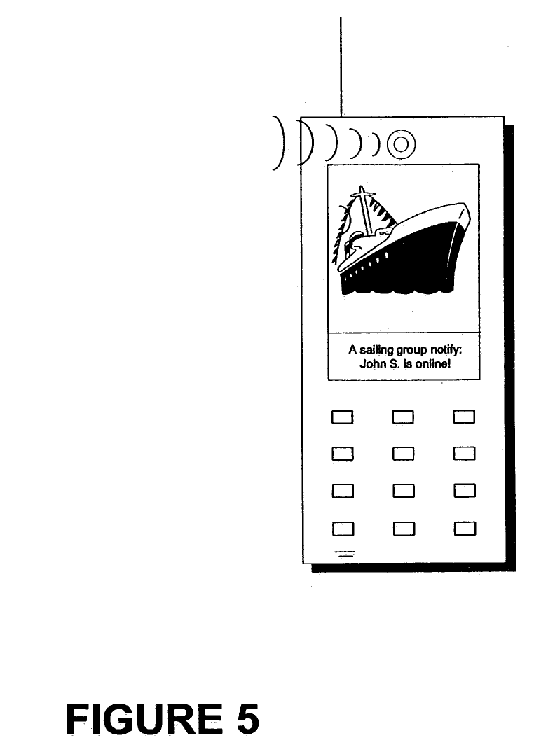

Notifications can vary considerably for different groups. Applied notification type and style may be selected from a list of predefined options stored in the terminal or they can be designed or at least tailored by the user if preferred. FIG. 5 depicts one possibility for the described second embodiment. The user has constructed a notification message comprising a text element “A sailing group notify: John S. is online!”, a sound sample of passenger ship's horn, and a figure representing a boat, and stored it in the memory of his mobile terminal. The terminal automatically sends this message to other sailing group members when the user visits the sailing club's WWW site. If some other group is also associated with the same action, the notification to be sent to the members of those groups may differ from the depicted one. If any specially designed notifications for a certain group are not determined, the notifications to be sent can be of the default type always available in the terminal.

Actions, Which launch the presence information update procedure according to the second embodiment of the invention, are not restricted to any specific class. Therefore, actions like accessing a WWW page or a certain service, changing active user profile or enabling the playing of ring tones, thus implicitly indicating the user is reachable, may be used for such purposes. Database 210 includes necessary couplings of actions, profiles and communication groups. Additionally, even accessing a certain service in a local server, e.g. reading a shared family calendar stored in home PC (Personal Computer) located at one's home with a Bluetooth enabled PDA (Personal Digital Assistant), can be considered to trigger the execution of said procedure. In that case, functionalities of a suggested personal communications device of the invention may be actually shared with several physically separate devices (e.g. a PDA with user interface wirelessly connected to a server with actual network connection) as mentioned earlier.

Notify messages can be constructed in various different ways but in the following, one possibility is described being targeted specially for the embodiment above. In this example, the notification is a slightly modified MMS message. MMS messages support flexible transmission of several media formats including traditional textual information, sounds, videos, pictures and synchronized presentations utilizing SMIL (Synchronized Multimedia Integration Language). SMIL is a presentation format comprising information about appearance of multimedia elements on a terminal's display.

X-Mms-Message-Type: m-send-req

X-Mms-Transaction-ID: 123

X-Mms-MMS-Version: 1.0

From: John Speedboat <john.speedboat@testsite.com>

To: Jesse Sailor <iesse.sailor@notify.org>

X-Mms-Message-Class: Auto

X-Mms-Priority: Low

X-Mms-Delivery-Report: No

X-Mms-Read-Reply: No

X-Notify: Activity

X-NotifyID: John Speedboat <john.speedboat@testsite.com>

Content-Type: application/vnd.wap.multipart.related;

start=<edit10@sailingclub.sml>;
boundary=“thisistheborder123”;
type=application/smil

--thisistheborder123
Content-ID: <edit10@sailingclub.sml>
Content-Type: application/smil; charset=“US-ASCII”
<smil>
<head>
<layout>
<root-layout width=“100” height=“200”/>
<region id=“Pic1” width=“100” height=“150” left=“0” top=“0” />
<region id=“Txt1” width=“100” height=“50” left=“0” top=“150” />
</layout>
</head>
<body>
<par dur = “5s”>
<img src=“Sailnotify.gif” region=“Pic1” />
<text src=“Sailnotify.txt” region=“Txt1” />
<audio src=“Sailnotify.amr”/>
</par>
</body>
</smil>
--thisistheborder123
Content-ID: <sail.notify@txt>
Content-Location: Sailnotify.txt
Content-Type: text/plain
A sailing group notify: John S. is online!
--thisistheborder123
Content-ID: <sail.notify@gif>
Content-Location: Sailnotify.gif
Content-Type: IMAGE/GIF
Content-Transfer-Encoding: BASE64
R01GODlhGAGgAPEAAPZRaCgoAAAACH+PUNvcHlyaWdodCAo
QykgMTk5NSBJRVRGLiBVbmF1dGhvcm16ZWQgZHVwbGljYXRpb24
gcHJvaGliaXR1ZC4A ...
--thisistheborder123
Content-ID: <sail.notify@amr>
Content-Location: Sailnotify.amr
Content-Type: audio/AMR
Content-Transfer-Encoding: BASE64
CH+PUNvcHlyaWdodCAoQykgMTk5NSBJRVRGLiBVbmF1dGhvcm
16ZWQgZHVwbGljYXRpb24gcHJvaGliaXR1ZC4AGODlhGAGg ...
--thisistheborder123--

MMS message header described here m-send-req and all other protocol data units for multimedia messaging service are specified in the WAP MMS Encapsulation Protocol document [1] by WAP Forum. For further reading, MMS Conformance document [2] by Nokia and Ericsson covers MMS interoperability issues and the basic structure of MMS messages. m-send-req is normally sent by MS (Mobile Station) to the MMS Proxy-Relay which handles further actions required for message transmission. SMIL presentations and other MMS specific data such as header fields are embedded in an extended MIME (Multi-purpose Internet Mail Extension) message traditionally used for sending composite e-mails on the Internet. See the following Internet Request For Comments documents for further information: RFC2045, RFC2046, RFC2387, RFC2557 [3]. Referring to RFC2046, header fields that begin with string “Content-” describe the content of a message and optional “X-” fields may be created for experimental or private purposes.

In the provided example, all mandatory header fields have been underlined for clarification purposes. X-Mms-Message-Type defines the type of the message, which in this case is m-send-req; send request of a MMS message. X-Mms-Transaction-ID is simply a unique identifier for the request and following replies. X-Mms-MMS-Version implies the used version of MMS standard, 1.0 for the present. From and To fields indicate addresses of the message sender and preferred recipient(s). X-Mms-Message-Class is set to Auto; message is automatically sent by the terminal and therefore further Delivery/Read-reports are not required. X-Mms-Priority Low indicates relatively low importance of the notification message for the recipient. X-Mms-Delivery-Report and X-Mms-Read-Reply fields are valued No as the message was classified “Auto” earlier. X-Notify is an invention specific field, which reflects the type of the notification. “Activity” refers to any kind of action, in this case surfing the WWW site associated with a certain communication group, which doesn't require real interaction with other members of a group, unlike some other actions like voice calls, real-time messaging etc. Values describing conventional communication action could be, for example, “Discussion”, which would indicate on-going voice-call, or “Messaging” which would indicate sending a message. Another invention specific field is X-NotifyID with senders address. This field can be used to specify the sender differently from the actual From field, if the sender is e.g. temporarily using a rental phone.

Content-Type is a standard MIME field, which has been valued application/wnd.wap.multipart.related disclosing that the separate parts of the message are related and cross-references from one to another are possible. Cross-referencing methods with Content-ID/Content-Location fields are explained in the reference RFC2557. If SMIL presentation is not available, other possible type is, for example, application/wnd.wap.multipart.mixed, which is a “standard” mixed set of parts. Start parameter identifies the presentation part from the overall message structure with ID “edit10@sailingclub.sml” and if not present, presentation part must be the first part of the multipart message. Boundary defines the notation which separates various parts of the multipart message. Therefore, it should be selected in a way that misreading is not possible. Selected “thisistheborder123” is supposed to provide that property. Expression “application/smil” determines the media type; this time top-level type is application and sub-level type is SMIL program.

Next part separated by the Boundary and identified with Content-ID “edit10@sailingclub.sml” includes SMIL program for controlling the appearance and presentation of the transmitted data. Layout section is separated by <layout> and </layout> tags. It defines the layout for multimedia message, which this time consists of one “slide”. Display is divided into two parts, one for the text named “Txtl” and one for the picture “Picl”. Body tags <body>and </body> include time container element identified with <par> and </par> and attribute dur which determines the duration of a single slide. Additionally, several slides can be concatenated to form a traditional slideshow with consecutive time container elements. In this example, only one slide is presented with separate image (Sailnotify.gif), text (Sailnotify.txt) and audio (Sailnotify.amr) parts, which are referenced by their Content-Location field.

Rest of the body parts comprise the aforementioned (text, picture, sound) elements. Note that although Content-Location fields were used for referencing of the multimedia elements, corresponding Content-ID's were presented as well. Text part consists of plain text while GIF image and AMR audio sample have been coded with BASE64 content-transfer-encoding method. Coding of binary data into text with BASE64 has been described in RFC1521. Coded data in the body parts is purely fictional and not fully illustrated as can been seen from the three dots following the first few rows of picture and sound data.

Affordable but purely text-based SMS messages provide another favourable option for sending notifications whenever more versatile data type alternatives offered by MMS are not necessary. Also direct terminal-to-terminal connections utilizing e.g. mobile IPv6 (Internet Protocol, version 6) can be exploited in notification procedures without traditional SMS/MMS message and service structures.

In a further embodiment of the invention, the communication initiator notifies the rest of the communication group members on behalf of the recipient. Therefore, the initiator may send an additional notification message wherein, for example, X-NotifyID field of the previous embodiment actually includes the ID of the far-end party, not of the initiator. In that case, the additional notification message could be of a preset type in order to be distinguishable from the initiator's own notify message, which possibly comprises highly personalized content as the text “A sailing group notify: John S. is online!” in the previous embodiment. In another solution, a single notification message may comprise two ID fields: one for the sender and one for the recipient of the original communication action.

Still an additional field may be used to inform if the recipient activity has been actually confirmed by the sender party. For example, in person-to-person voice call scenario, the call originator and related personal communications device almost certainly identify if the far-end party really is active and on-line. Optionally, the notifications could be purely sent on basis of connection parties, regardless of the actual response received from the far-end. Of course, the communication devices may occasionally get confused by the answering machines etc. preventing the truthful presence info to be transmitted to the non-involved group members.

Functionality of the presented embodiment can be made conditional by requiring a separate permission from the recipient before notify “on behalf” can be executed. Authorization may be received automatically from the recipient during the communication action e.g. according to a preset parameter stored in the recipient's communications device. For example, invention specific software may send a SMS which is interpreted by the initiator's personal communications device. Described authorization technique mainly consists of sending/receiving a message and parsing text, and is therefore considered obvious to implement by a person skilled in the art.

When utilizing this embodiment, the receiving end of the communication action typically does not send any notification messages if it recognises the communication initiator as a member of the communication group being defined in his personal communications device. Then the receiving end possibly authorizes the communication initiator to continue with the notification procedure on his behalf as pointed out above. In these cases, communication groups should contain exactly the same members in all related communication devices to provide consistent notification service during every possible initiator-recipient scenario. Therefore, the member list should preferably be updated and frozen in consensus with all members or optionally, the communication group member information should be exchanged regularly between group members either automatically or manually by exploiting e.g. SMS/MMS messaging.

Concerning all presented embodiments, one option for automatized communication group (member list) update can rely on the actual notification traffic and preset time “countdown” parameters. For example, if a new notification message is received but the sender does not seem to belong to the communication group somehow mentioned (e.g. in a header field) in the notification, he can be automatically added to that particular group by the receiving personal communications device. On the other hand, if another group member has not been active for a certain time period according to a member specific “countdown timer” stored in the personal communications device, he can be removed from the member list in some cases, initial or updated communication group definitions can be made retrievable from an external device such as a server, which takes care of addition/removal of group members e.g. according to received registration or membership cancellation messages. However, actual notifications are still to be transmitted without a notification server. All proposed methods should be implemented in a way that utilization of external devices is not obligatory in any phase of the notification procedure, including retaining group membership information.

In a further embodiment of the invention a visual and/or audio symbol is attached to each communication group and upon detecting activity in a group by receiving a notification message, a symbol associated with that group is presented to the user. Actual notification message does not have to comprise any multimedia elements like the aforesaid symbol, as the symbol may have been, for example, received earlier in a separate message or created by the user himself, stored and associated with certain group. Anyhow, mandatory aspect of this embodiment still is that the notification message has to be recognized from other messages by e.g. exploiting invention specific header fields.

Referring to all presented embodiments, if modifications are not desirable in existing supported message types and new ones are not going to be developed, also payload of an unmodified, standard message can be used in the implementation of the notification method. For example, recalling how the boundary string separates the body parts of a MMS message, a similar solution can be utilized for identification of the notification message by embedding a reserved data pattern, e.g. a certain character string, into the payload of otherwise standard message. This approach correspondingly requires that the data pattern is carefully selected to avoid miss interpretations.

Today's people are independent in many ways, as we are not tied up with a certain location, culture, surrounding people or social background so tightly anymore. All this results not least from the advent of modern telecommunication systems which practically are global and most importantly, free of location. Time is maybe the most valuable resource in our everyday life and it is a question of how we would like to spend it, as there certainly are numerous options available to everyone. One obvious and common goal is to do and achieve as much as possible. With a life precept like that, it is undoubtedly hard to maintain the social relationships with other people, as it usually requires some extra effort from people ‘living on the edge’, chronically suffering from lack of time. This invention is likely to offer relief in a form of somewhat unintentional but surprisingly refreshing communication. Furthermore, the proposed method can be exploited in maintaining an automated, portable database of user activity/presence information.

The scope of the invention can be found from the following independent claims. However, utilized personal communications devices, actions and notifications may vary significantly depending on the current scenario, still converging to the basic ideas of this invention. Therefore, the invention is not strictly limited to the embodiments described above.

### REFERENCES

[1] WAP: MMS Encapsulation Protocol V. Jan. 5, 2002, URL: http://www.wapforum.org/what/technical.htm, WAP Forum 2002

[2] MMS Conformance Document V. 1.1, URL: http://www.thewirelessfag.com/14.4.as, Nokia & Ericsson 2001

[3] Internet FAQ Consortium, URL: http://www.faqs.org/rfcs/rfcXXXX.html, wherein XXXX is the identification number of desired RFC document (e.g. 2557)

1. A method for notifying communication group members, wherein said notifying is to be performed by a personal communications device operable in a telecommunications network, wherein at least one communication group and the members of said communication groups have been defined in said personal communications device, said device executing actions, said method comprising the steps of
defining the communication actions associated with the notification method (302),
identifying the communication actions associated with the notification method (306),
identifying a communication group having the far-end party of the communication action as a member (308), and
sending notifications to target devices, the users of which belonging to at least one said identified communication group (310).

2. A method of claim 1, further comprising a step of constructing an address table of target devices from a plurality of communication group member lists, said lists comprising the far-end party of the communication action as a member.

3. A method of claim 2, wherein each address appears not more than once in said constructed address table.

4. A method of claim 1, further comprising a step of receiving notification messages from other devices.

5. A method of claim 4, wherein a user presence database stored in said personal communications device is updated based on received notification data.

6. A method of claim 1, further comprising a step of notifying said target devices on behalf of said far-end party.

7. A method of claim 4, wherein said notifications comprise presence information of said far-end party.

8. A method of claim 1, wherein said identification of actions is based on a predefined list of communication actions triggering the sending of notifications.

9. A method of claim 1, wherein said notifications comprise one of the following: sounds to be played by said target devices, textual information, or visual symbols associated with said communication groups.

10. A method of claim 1, wherein said notification is substantially a SMS (Short Message Service) or MMS (Multimedia Messaging Service) message.

11. A method of claim 1, wherein said notification is sent over a connection utilizing substantially IPv6 (Internet Protocol, version 6).

12. A method of claim 1, wherein said communication action is substantially one of the following: initiating a call, answering a call, sending a message, receiving a message, or reading a received message.

13. A method of claim 1, further comprising a step of adding a new member to a communication group upon receiving a notification associated with the communication group from a person previously not belonging to said communication group.

14. A method of claim 1, further comprising a step of removing at least one member from the communication group, which member has not been active for a predetermined time limit.

15. A method of claim 1, further comprising a step of contacting a server for acquiring or updating communication group definitions.

16. A method for notifying communication group members, wherein said notifying is to be performed by a personal communications device operable in a telecommunications network, wherein at least one communication group and the members of said communication groups have been defined in said personal communications device, said device executing actions, said method comprising the steps of
defining the associations of profiles with actions (404),
defining the associations of profiles with communication groups (406),
identifying the actions associated with a profile (410),
mapping actions to profiles connected to at least one communication group (412), and
sending notifications to target devices, the users of which belonging to at least one communication group (416).

17. A method of claim 16, further comprising a step of constructing an address table of target devices from a plurality of communication group member lists (414).

18. A method of claim 17, wherein each address appears not more than once in said constructed address table.

19. A method of claim 16, further comprising a step of receiving notification messages from other devices.

20. A method of claim 19, wherein user presence database stored in said personal communications device is updated based on received data.

21. A method of claim 16, wherein said notifications comprise substantially one of following: sounds to be played by said target devices, textual information, or visual symbols associated with said communication groups.

22. A method of claim 16, wherein said notification is substantially a SMS (Short Message Service) or MMS (Multimedia Messaging Service) message.

23. A method of claim 16, wherein said notification is sent over a connection utilizing substantially IPv6 (Internet Protocol, version 6).

24. A method of claim 16, wherein said action is substantially one of following: initiating a call, answering a call, sending a message, receiving a message, or reading a received message.

25. A method of claim 16, wherein said action is substantially accessing a service.

26. A method of claim 16, wherein said action is substantially part of a procedure for accessing the Internet.

27. A method of claim 16, wherein said action is substantially switching the user profile.

28. A method of claim 16, further comprising a step of adding a new member to a communication group upon receiving a notification associated with the communication group from a person previously not belonging to said communication group.

29. A method of 16, further comprising a step of removing at least one member from the communication group, which member has not been active for a predetermined time limit.

30. A method of claim 16, further comprising a step of contacting a server for acquiring or updating communication group definitions.

31. A personal communications device operable (206) in a telecommunications network, comprising processing means (214) and memory means (202, 210, 212) for processing and storing instructions and data, said personal communications device arranged to identify actions from a plurality of actions, arranged to associate said identified actions with at least one communication group, and arranged to send notifications to target devices, the users of which belonging to at least one of said at least one communication group.

32. A personal communications device of claim 31, further arranged to associate said identified actions with at least one communication group by retrieving the communication group membership information of the far-end party involved in said action from the database (210) stored in said personal communications device.

33. A personal communications device of claim 31, further arranged to receive notification messages from other devices.

34. A personal communications device of claim 33, further arranged to update user presence database (210) based on received data.

35. A personal communications device of claim 31, further arranged to notify said target devices on behalf of said far-end party.

36. A personal communications device of claim 33, wherein said notifications comprise presence information of said far-end party.

37. A personal communications device of claim 31, further arranged to associate said identified actions with at least one communication group by mapping said actions to profiles connected to at least one communication group.

38. A personal communications device of claim 31, further arranged to construct an address table of target devices from a plurality of communication group member lists.

39. A personal communications device of claim 31, which is substantially a GSM (Global System for Mobile communications) or UMTS (Universal Mobile Telecommunication System) terminal.

40. A personal communications device of claim 31, further arranged to identify said actions on the basis of a predetermined list of actions associated with sending of notifications.

41. A personal communications device of claim 31, further arranged to send said notifications substantially as SMS (Short Message Service) or MMS (Multimedia Messaging Service) messages.

42. A personal communications device of claim 31, further arranged to transmit said notifications over a connection utilizing substantially IPv6 (Internet Protocol, version 6).

43. A personal communications device of claim 33, further arranged to add a new member to a communication group upon receiving a notification associated with the communication group from a person previously not belonging to said communication group.

44. A personal communications device of claim 31, further arranged to remove group members from the group, which members have not been active for a predetermined time limit.

45. A personal communications device of claim 31, comprising at least two devices arranged to communicate with each other.
